(19) United States
(12) Patent Application Publication
(10) Pub. No.: US 2007/0080635 A1
(43) Pub. Date: Apr. 12, 2007

(54) Light emitting device for visible light generation

(75) Inventor: Lieh-Chung Wang, Lujhou City (TW)

Correspondence Address: BACON & THOMAS, PLLC, 625 SLATERS LANE, FOURTH FLOOR, ALEXANDRIA, VA, 22314, US

(73) Assignee: Luminoso Photoelectric Technology Co., Taipei County (TW)

(21) Appl. No.: 11/244,279

(22) Filed: Oct. 6, 2005

(51) Int. Cl. H05B 33/04; H01J 1/62

(52) U.S. Cl. 313/512

(57) ABSTRACT

There is provided a light emitting device for visible light generation, including a light emitting chip, which can emit a first light having a wavelength between 250 nm and 420 nm; an organic phosphor layer, which is formed by applying organic polymers on the output surface of the light emitting chip using vacuum evaporation, coating, screen printing, offset printing, sputtering, dripping, casting, or adhering method; and an encapsulation layer embedded with a plurality of nanograde crystalline grains, wherein the first light emitted from the light emitting chip can excite the organic phosphor layer, which subsequently emits a second light having a wavelength between 380 nm and 800 nm, and the second light and the first light are mixed within the encapsulation layer to produce visible light with excellent color uniformity outwards from the encapsulation layer.

### BACKGROUND OF THE INVENTION

1. Field of the Invention

The present invention relates generally to a light emitting device, and in particular to a light emitting device for visible light generation, which can emit various visible light, such as white light, red light, green light, blue light, yellow light, orange light, indigo light or violet light, with excellent color uniformity and color rendering.

2. The Prior Arts

LEDs are generally classified into visible light LEDs and invisible light LEDs based on the wavelengths of light emitted by LEDs. The visible light LEDs are often used in digital clocks, bank exchange rate displays, traffic signals, outdoor display panels, and the like. The invisible light LEDs are often used in information and communication products, such as remote controls, infrared light wireless communication equipments, automatic doors, and automatic flushers, and the like. Nowadays, the LED markets are especially growing on the visible light LEDs. Among them, the white light LEDs have been most rapidly developed. On the other hand, the invisible light LED markets remains steady.

The principle behind LEDs is that the electron-hole pairs are generated when the excitation is provided by current flow through the LED, and the LED subseqently emits the first light (ultraviolet light, or blue light) when the recombination of the electron-hole pairs occurs. The first light can be absorbed by a phosphor, and then converted into the second light (in the range of visible light), and thus the white or other visible light can be produced after the first light which is not absorbed by the phosphor and the second light which is emitted by the phosphor are mixed. By varying proportions of different types of phosphors, LED can emit different color (such as cold color, or warm color) light as fluorescent lamps do.

Most of LEDs emit visible light (such as white light, red light, green light, blue light, yellow light, orange light, indigo light or violet light) by exciting an inorganic phosphor material with ultraviolet light. For example, U.S. Pat. No. 6,555,958 disclosed that the blue-to-green light was produced by exciting the inorganic phosphor, such as Ba₂SiO₄:Eu²⁺, using ultraviolet light ; U.S. Pat. No. 6,501,100 disclosed that the white light was produced by exciting the inorganic phosphor, such as (Sr_{0.8} Eu_{0.1} Mn_{0.1}) ₂ P₂O₇, using ultraviolet light; U.S. Pat. No. 6,621,211 disclosed that the white light was produced by exciting the inorganic phosphor, such as (Ba,Sr,Ca)₂SiO₄:Eu²⁺, using ultraviolet light; U.S. Pat. No. 6,294,800 disclosed that the white light was produced by exciting the inorganic phosphor, such as Ca₈Mg(SiO₄)₄Cl₂:Eu²⁺,Mn²⁺, using ultraviolet light; U.S. Pat. No. 6,661,862 disclosed that the yellow-to-orange light was produced by exciting the inorganic phosphor, such as (Ca,Sr,Ba,Mg)₅(PO₄)₃:Eu²⁺,Mn², using near UV/blue light; US2003067265 disclosed that the white light was produced by exciting the inorganic phosphor, such as A₂₋₂ₓNa₁₊ₓEₓD₂V₃O₁₂ (wherein A may be calcium, barium, strontium, or combinations of these three elements, E may be europium, dysprosium, samarium, thulium, or erbium, or combinations thereof, and D may be magnesium or zinc, or combinations thereof, and the value of x ranges from 0.01 to 0.3, inclusive), using ultraviolet light; US2003067008 disclosed that the white light was produced by exciting the inorganic phosphor, such as (Sr_{0.90-0.99}Eu_{0.01-0.1})₄Al₁₄O₂₅, using ultraviolet light; US2004007961 disclosed that the white light was produced by exciting the inorganic phosphor, such as Sr₂P₂O₇:Eu²⁺, Mn²⁺, using ultraviolet light. However, the foregoing prior art applications all face the facts that the inorganic phosphors for use in LEDs do not reflect light well, and these LEDs have poor power quality. Therefore, the present invention has been developed as a result of studies to solve the problems set forth above.

### SUMMARY OF THE INVENTION

The objective of the present invention is to provide a light emitting device for visible light generation, and the light emitting device emits the first light (violet light/ultraviolet light) which in turn excites the organic phosphor layer composed of varying proportions of red, yellowish green, and blue organic phosphors, and the organic phosphor layer subsequently emits the second light, mixing with the first light which is not absorbed by the organic phosphor layer, thus producing high-power visible light (such as white light, red light, green light, blue light, yellow light, orange light, indigo light or violet light) with excellent color uniformity.

To achieve the foregoing objective, the present invention provides a light emitting device for visible light generation, and the light emitting device comprises: a light emitting chip, functioning as a light source, which can emit a first light having a wavelength between 250 nm and 420 nm (i.e. between violet light and ultraviolet light); an organic phosphor layer, which is formed by applying organic polymers on the output surface of the light emitting chip using vacuum evaporation, coating, screen printing, offset printing, sputtering, dripping, casting, or adhering method; and an encapsulation layer embedded with a plurality of nanograde crystalline grains, which encloses the light emitting chip and the organic phosphor layer, wherein the first light emitted from the light emitting chip can excite the organic phosphor layer, which subsequently emits a second light having a wavelength between 380 nm and 800 nm nm which is different form the first light, and the second light and the first light which is not absorbed by the organic phosphor layer are mutually mixed within the encapsulation layer to produce a mixed light, which is further mixed by focusing and scattering the mixed light with a plurality of nanograde crystalline grains embedded in the encapsulation layer, then emitting various visible light (such as white light, red light, green light, blue light, yellow light, orange light, indigo light or violet light) with excellent color uniformity outwards from the encapsulation layer, wherein the organic phosphor layer is composed of varying proportions of red, yellowish green, and blue organic phosphors so that the light emitting device for visible light generation can emit high power visible light, such as white light, red light, green light, blue light, yellow light, orange light, indigo light or violet light.

It is worthy to be noticed that the organic polymers applied on the output surface of the light emitting chip to form the organic phosphor layer of the present invention include:

Aminotriazine-Urea-Formaldehyde-Sulphonamide Type; or

4,4′-Bis[2-(2-methoxyphenyl)ethenyl]-1,1′-diphenyl Type.

By varying proportions of red, yellowish green, and blue organic phosphors composed of the above-mentioned two type organic polymers, the light emitting device for visible light generation can emit high power visible light, such as white light, red light, green light, blue light, yellow light, orange light, indigo light or violet light.

The advantages of the light emitting device of the presnt invention are that violet/ultraviolet light emitted from the light emitting chip excite the organic phosphor layer composed of varying proportions of red, yellowish green, and blue organic phosphors, which subsequently emits a second light, and the second light and violet/ultraviolet light which is not absorbed by the organic phosphor layer are mutually mixed within the encapsulation layer to produce a mixed light, which is further mixed by focusing and scattering the mixed light with a plurality of nanograde crystalline grains embedded in the encapsulation layer, then emitting a high-power visible light (such as white light, red light, green light, blue light, yellow light, orange light, indigo light or violet light) with excellent color uniformity. Therefore, the problems of LED in weak reflection, and low light-emitting power can be solved.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a cross-sectional view of a light emitting device for visible light generation in accordance with the present invention;

FIG. 2 is a flow chart for producing visible light in accordance with the present invention; and

FIG. 3 is a partially enlarged view of the encapsulation layer arranged in the light emitting device for visible light generation shown in FIG. 1.

### DETAILED DESCRIPTION OF THE PREFERRED EMBODIMENT

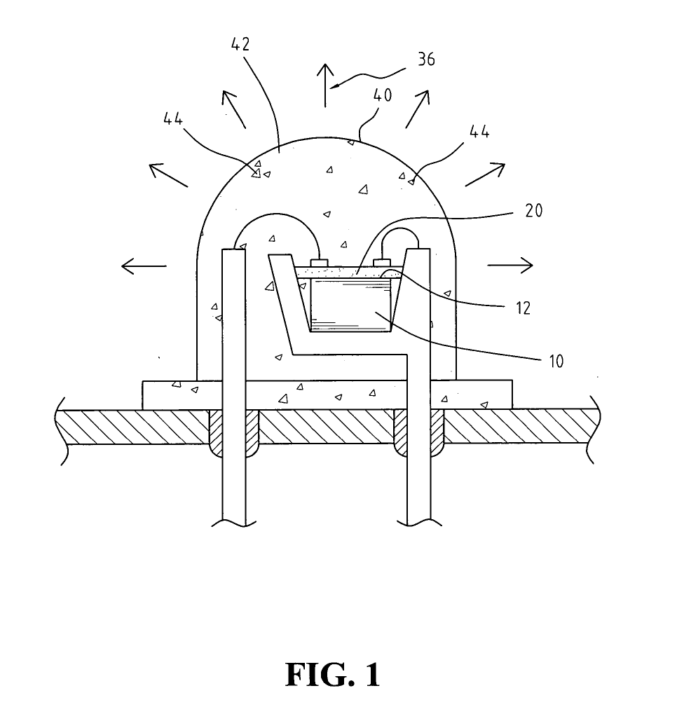

FIG. 1 is a cross-sectional view of a light emitting device for visible light generation in accordance with the present invention. In FIG. 1, the light emitting chip 10, functioning as a light source, emits a first light having a wavelength between 250 nm and 420 nm (i.e. between violet light and ultraviolet light) when subjected to an electric current. The organic phosphor layer 20 composed of varying proportions of red, yellowish green, and blue organic phosphors is formed by applying the organic polymers (as listed in the following text) on the output surface 12 of the light emitting chip 10 using vacuum evaporation, coating, screen printing, offset printing, sputtering, dripping, casting, or adhering method. The thickness of organic phosphor layer 20 is preferably in the range from 500 Å to 5000 Å, and also can depend upon the need of the designer. The organic polymers used in this embodiment include:

Aminotriazine-Urea-Formaldehyde-Sulphonamide Type; or

4,4′-Bis[2-(2-methoxyphenyl)ethenyl]-1,1′-diphenyl Type.

By changing the kinds or numbes of the substituents, the above-listed two type organic polymers as phosphor can emit different color visible light when excited by the light from the light source. Moreover, by varying proportions of red, yellowish green, and blue organic phosphors composed of the above-listed two type organic polymers, the light emitting device for visible light generation can emit high power visible light, such as white light, red light, green light, blue light, yellow light, orange light, indigo light or violet light. The encapsulation layer 40 is composed of well-mixed transparent resin 42 and a plurality of nanograde crystalline grains 44. These nanograde crystalline grains 44 can focus and scatter light, and can be transparent or translucent. The particle size of these nanograde crystalline grains 44 is preferably less than 100 nm. These nanograde crystalline grains 44 appear as particles when observed under a microscope, but appear as powders when observed by human eyes. The light emitting device can emit various visible lights 36 (such as white light, red light, green light, blue light, yellow light, orange light, indigo light or violet light) outwards from the encapsulation layer 40, and the visible lights 36 has excellent color uniformity and color rendering.

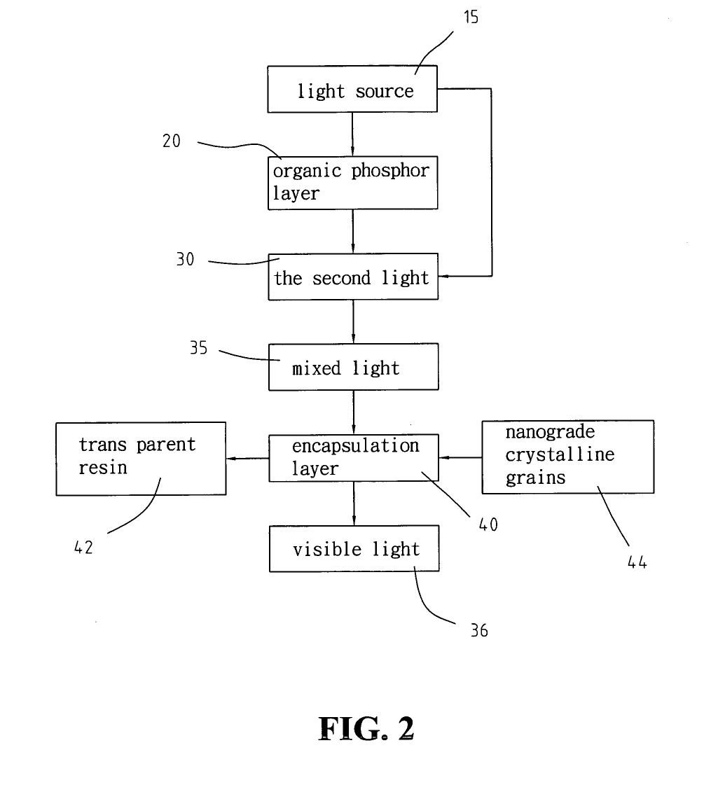

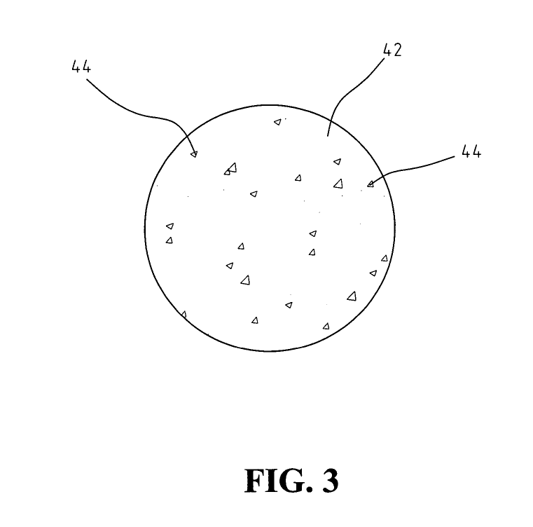

FIG. 2 is a flow chart for producing visible light in accordance with the present invention; and FIG. 3 is a partially enlarged view of the encapsulation layer arranged in the light emitting device for visible light generation shown in FIG. 1. In FIG. 2 and FIG. 3, the light source 15 emits a first light having a wavelength between 250 nm and 420 nm (i.e. between violet light and ultraviolet light) which in turn excites the organic phosphor layer 20. Subsequently, the excited organic phosphor layer 20 emits a second light 30 having a wavelength between 380 nm and 800 nm. The organic phosphor layer 20 is formed by applying the above-mentioned organic polymers on the output surface 12 of the light emitting chip 10 using vacuum evaporation, coating, screen printing, offset printing, sputtering, dripping, casting, or adhering method. The organic phosphor layer 20 has excellent homogeneity and adhesion because it is formed on the output surface 12 of the light emitting chip 10 by cool forming, which will bring about an improvement in the homogeneity and the intensity of the visible light subsequently produced after light mixing. The organic phosphor layer 20 is composed of varying proportions of a red organic phosphor, a yellowish green organic phosphor, and a blue organic phosphor. Then, the second light 30 and the first light which is not absorbed by the organic phosphor layer 20 are mixed to produce a mixed light 35 (i.e. visible light). While the mixed light 35 pass through the transparent encapsulation layer 40, it is focused and scattered by a plurality of nanograde crystalline grains 44 embedded in the encapsulation layer 40. Therefore, the visible light 36 (such as white light, red light, green light, blue light, yellow light, orange light, indigo light or violet light) with excellent color uniformity, color rendering, and intensity will be emitted outwards from the encapsulation layer 40 because the mixed light 35 is further well mixed by focusing and scattering with nanograde crystalline grains 44 embedded in the encapsulation layer. The encapsulation layer 40 is composed of a transparent resin 42 and a plurality of transparent or translucent nanograde crystalline grains 44. The mixing ratio for the transparent resin 42 and the transparent or translucent nanograde crystalline grains 44 is preferably 90:10. These nanograde crystalline grains 44 may appear as round shape-, oval shape-, polygon shape-, or irregular shape-nanoparticles.

In another embodiment, the organic polymers (as listed in the above text) are applied on the outside surface of the encapsulation layer 40. The organic polymers may cover substantially all of the outside surface of the encapsulation layer 40.

It will be apparent to those skilled in the art that various modifications and variations can be made in the present invention without departing from the spirit or scope of the present invention. Thus, it is intended that the present invention cover the modifications and the variations of this invention provided they come within the scope of the appended claims and their equivalents.

What is claimed is:

1. A light emitting device for visible light generation, comprising
a light emitting chip, functioning as a light source, which can emit a first light having a wavelength between 250 nm and 420 nm;
an organic phosphor layer, which is formed by applying Aminotriazine-Urea-Formaldehyde-Sulphonamide Type organic polymers on an output surface of the light emitting chip; and
an encapsulation layer embedded with a plurality of nanograde crystalline grains, which encloses the light emitting chip and the organic phosphor layer,
wherein the first light emitted from the light emitting chip can excite the organic phosphor layer, which subsequently emits a second light which is different from the first light, and the second light and the first light which is not absorbed by the organic phosphor layer are mutually mixed within the encapsulation layer to produce a mixed light, which is further mixed by focusing and scattering the mixed light with a plurality of nanograde crystalline grains embedded in the encapsulation layer, then emitting a visible light with excellent color uniformity and color rendering outwards from the encapsulation layer.

2. The device as claimed in claim 1, wherein a method for applying Aminotriazine-Urea-Formaldehyde-Sulphonamide Type organic polymer on an output surface of the light emitting chip includes vacuum evaporation, coating, screen printing, offset printing, sputtering, dripping, casting, or adhering.

3. The device as claimed in claim 1, wherein the encapsulation layer is composed of a transparent resin, and the nanograde crystalline grains.

4. The device as claimed in claim 1, wherein the nanograde crystalline grains have a particle size less than 100 nm, which are transparent or translucent.

5. The device as claimed in claim 1, wherein the second light has a wavelength between 380 nm and 800 nm.

6. The device as claimed in claim 1, wherein the organic phosphor layer is composed of varying proportions of a red organic phosphor, a yellowish green organic phosphor, and a blue organic phosphor, in which the red, yellowish green, and blue organic phosphors are made of the organic polymers of Aminotriazine-Urea-Formaldehyde-Sulphonamide Type.

7. A light emitting device for visible light generation, comprising
a light emitting chip, functioning as a light source, which can emit a first light having a wavelength between 250 nm and 420 nm;
an organic phosphor layer, which is formed by applying 4,4′-Bis[2-(2-methoxyphenyl)ethenyl]-1,1′-diphenyl Type organic polymers on an output surface of the light emitting chip; and
an encapsulation layer embedded with a plurality of nanograde crystalline grains, which encloses the light emitting chip and the organic phosphor layer,
wherein the first light emitted from the light emitting chip can excite the organic phosphor layer, which subsequently emits a second light which is different from the first light, and the second light and the first light which is not absorbed by the organic phosphor layer are mutually mixed within the encapsulation layer to produce a mixed light, which is further mixed by focusing and scattering the mixed light with a plurality of nanograde crystalline grains embedded in the encapsulation layer, then emitting a visible light with excellent color uniformity and color rendering outwards from the encapsulation layer.

8. The device as claimed in claim 7, wherein a method for applying 4,4′-Bis[2-(2-methoxyphenyl)ethenyl]-1,1′-diphenyl Type organic polymer on an output surface of the light emitting chip includes vacuum evaporation, coating, screen printing, offset printing, sputtering, dripping, casting, or adhering.

9. The device as claimed in claim 7, wherein the encapsulation layer is composed of a transparent resin, and the nanograde crystalline grains.

10. The device as claimed in claim 7, wherein the nanograde crystalline grains have a particle size less than 100 nm, which are transparent or translucent.

11. The device as claimed in claim 7, wherein the second light has a wavelength between 380 nm and 800 nm.

12. The device as claimed in claim 7, wherein the organic phosphor layer is composed of varying proportions of a red organic phosphor, a yellowish green organic phosphor, and a blue organic phosphor, in which the red, yellowish green, and blue organic phosphors are made of the organic polymers of 4,4′-Bis[2-(2-methoxyphenyl)ethenyl]-1,1′-diphenyl Type.
